(19) United States
(12) Patent Application Publication
(10) Pub. No.: US 2005/0252066 A1
(43) Pub. Date: Nov. 17, 2005

(54) Magnetically attached decoy wings

(76) Inventor: Fredrick L. Couvillion III, Shreveport, LA (US)

Correspondence Address: John M. Harrison, 2139 E. Bert Kouns, Shreveport, LA, 71105, US

(21) Appl. No.: 10/452,641

(22) Filed: Jun. 2, 2003

Related U.S. Application Data
(60) Provisional application No. 60/384,785, filed on Jun. 3, 2002.

(51) Int. Cl. A01M 31/06

(52) U.S. Cl. 43/3

(57) ABSTRACT

Magnetically attached decoy wings which are each characterized by a wing of selected size, color and design, fitted with a mount collar sized to slip-fit on each ferrous drive shaft of a decoy, with a magnet provided in the bore of each mount collar for contacting and exerting an attractive magnetic force upon the ferrous drive shafts when the mount collars are seated on the respective drive shafts. Each mount collar is slip-fitted on the corresponding drive shaft or on an adaptor inserted on the drive shaft, to facilitate easy attachment and detachment of the wings to and from the drive shafts and each mount collar is designed to rotate, both with the drive shaft and with respect to the drive shaft, to avoid damage to the wing or the decoy if the rotating wing or wings should strike an obstacle. In a preferred embodiment the decoy wings are characterized by a plastic corrugated core sandwich construction and feature a mount rod extending through each corrugated center or core from the wing base toward the wing tip, for mounting in each of the collars, respectively, and a mount pin extends transversely through each mount collar and the corresponding mount rod for mounting the mount rods and the decoy wings on the mount collars.

### CROSS-REFERENCE TO RELATED APPLICATIONS

This application claims the benefit and incorporates by reference prior filed copending U.S. Provisional Application Ser. No. 60/384,785, filed Jun. 3, 2002.

### SUMMARY OF THE INVENTION

This invention relates to motorized decoys fitted by various techniques such as thumb screws, with rotating wings of various design, to simulate the flapping wings of waterfowl and other game birds. More particular, the invention includes decoy wings for mounting on the oppositely-disposed ferrous rotating shafts of a motorized decoy, each wing of which includes a mount collar to slip fit on a corresponding drive shaft and a magnet provided in each of the mount collars for exerting an attractive force on the ends of the corresponding ferrous drive shafts and removably maintaining the wings on the drive shafts. Since the drive shafts are typically round in cross-section, each mount collar bore is also round to facilitate independent rotation of the wings with respect to the rotating drive shafts in the event the wing or wings strike an obstacle, to avoid damage to the wings, the drive shafts and the decoy. The decoy wings are removed from the corresponding rotating drive shafts by exerting pressure outwardly of the decoy, thus breaking the magnetic attraction between the magnets in the mount collars and the end of each ferrous (bivalent iron) drive shaft. In a preferred embodiment each decoy wing is characterized by a plastic corrugated core, sandwich construction which receives a mount rod extending through the corrugated core, from the wing base toward the wing tip, which mount rod is, in turn, typically seated in the corresponding mount collar by means of a rod mount pin, such as a roll pin. Each magnet is typically glued in one end of the mount collar by means of a hole drilled through the mount collar, or by the application of a suitable adhesive into the mount collar bore to the base of the mount collar or applied to the magnet itself.

### BRIEF DESCRIPTION OF THE DRAWINGS

The invention will be better understood by reference to the accompanying drawings, wherein:

FIG. 1 is a perspective view of a preferred embodiment of the decoy wings of this invention, mounted on the oppositely-disposed ferrous shafts of a decoy (illustrated in phantom);

FIG. 2 is a perspective view of the right hand decoy wing illustrated in FIG. 1, detached from the corresponding ferrous shaft;

FIG. 3 is an exploded view of the decoy wing illustrated in FIG. 2, more particularly illustrating a preferred mount rod for extending into the wing core and attached to a mount collar, and a magnet seated in the mount collar;

FIG. 4 is a sectional view taken along line 4-4 of the right-hand decoy wing illustrated in FIG. 1, more particularly illustrating the location of the magnet inside the collar bore of the mount collar and the mount collar mounted on the mount rod using a rod mount pin, with the mount collar removably slipped-fitted on the ferrous wing drive shaft of a mechanical decoy;

FIG. 5 is a sectional view of the decoy wing, mount collar, mount rod, rod mount pin and magnet illustrated in FIG. 4, more particularly illustrating the collar bore of the mount collar, which receives the magnet and the ferrous drive shaft of the motorized decoy; and

FIG. 6 is a sectional view taken along line 6-6 of the right-hand decoy wing, illustrated in FIG. 1, more particularly illustrating a plastic corrugated core, sandwich wing construction.

### DESCRIPTION OF THE PREFERRED EMBODIMENTS

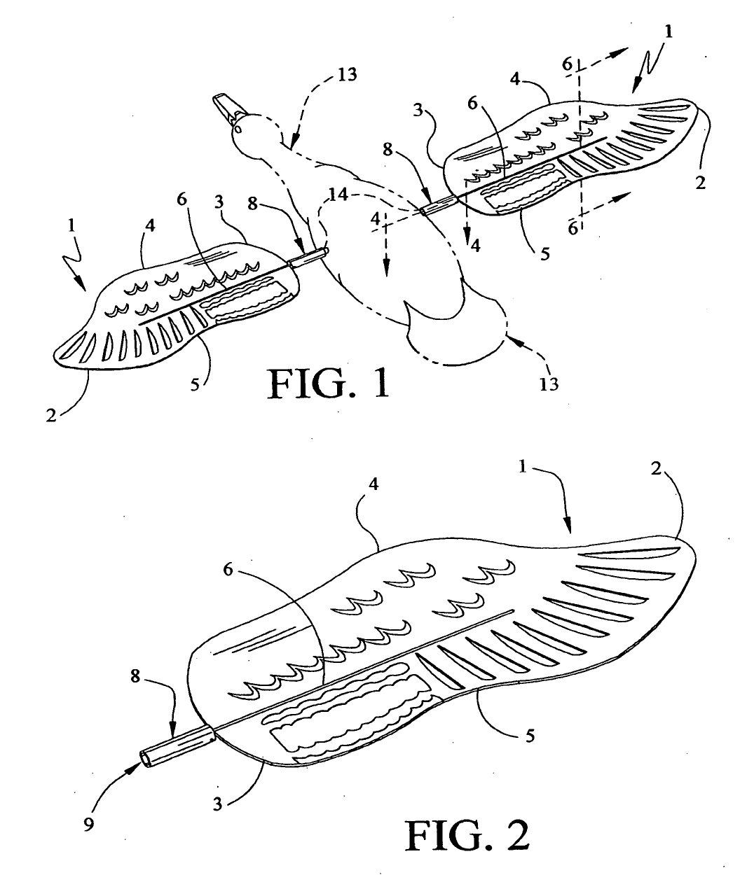

Referring initially to FIGS. 1-3 and 6 of the drawings, the magnetically attached decoy wings of this invention are generally illustrated by reference numeral 1 and each includes a wing tip 2, extending from a wing base 3 and defining a shaped leading edge 4 and a trailing edge 5, typically as illustrated. In a preferred embodiment of the invention a mount rod 6 of suitable size extends through the typically corrugated core of the plastic decoy wings 1, having wing panels la enclosing a corrugated core lb, as illustrated in FIG. 6, and one end of the mount rod 6 extends from each wing base 3, for purposes which will be hereinafter further described. In a most preferred embodiment of the invention each mount rod 6 is inserted and glued in a pre-prepared rod opening 7, extending through the corrugated core 1b, from each wing base 3, through a portion of the decoy wing 1 toward the wing tip 2. This design facilitates rotation of the decoy wings 1 along a longitudinal axis that corresponds to each mount rod 6, with respect to the decoy 13, as illustrated in phantom in FIG. 1. This wing rotation is typically effected by means of an electric motor and battery pack (not illustrated) placed inside the cavity of the decoy 13, which motor is fitted with a pair of rotating ferrous metal (bivalent iron) wing drive shafts 14 extending from the sides of the decoy 13, as further illustrated in FIG. 1. Accordingly, it will be appreciated from a consideration of FIG. 1 of the drawings that the decoy wings 1 are designed to rotate by operation of the electric motor located inside the decoy 13 as the ferrous wing drive shafts 14 rotate.

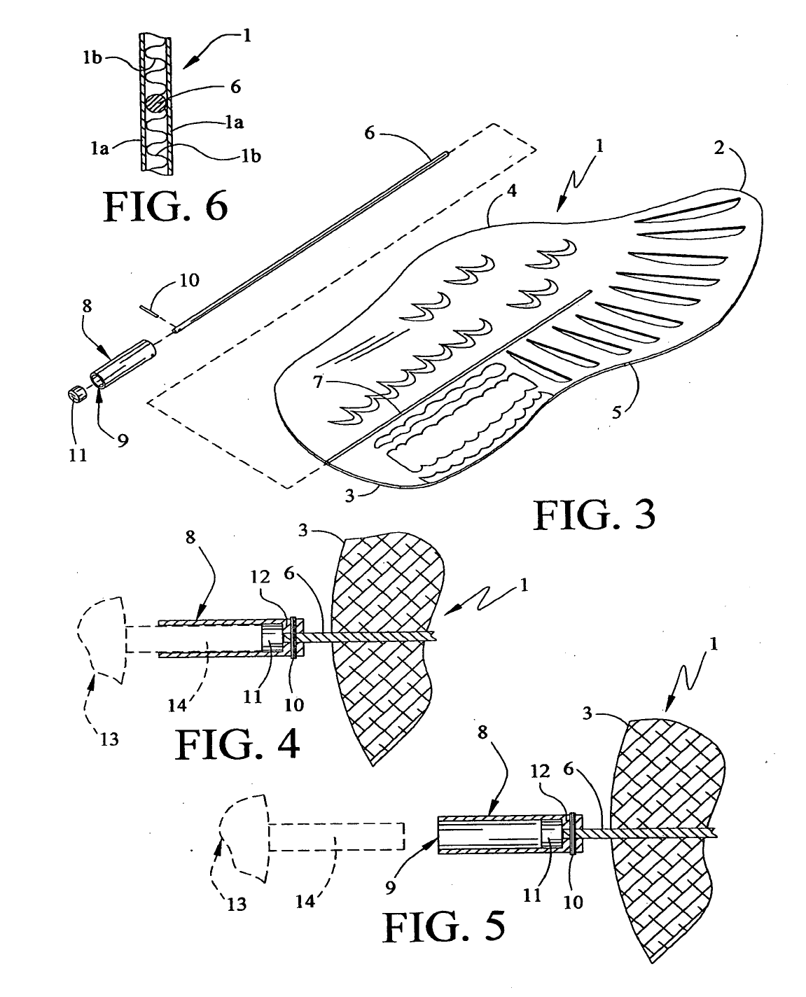

As further illustrated in FIGS. 1-3 of the drawings, a mount collar 8 is provided on each of the decoy wings 1 and in a preferred embodiment, the mount collars 8 are attached to the respective mount rods 6 extending through the corresponding rod openings 7 in the decoy wings 1, as further illustrated in FIGS. 2 and 3 of the drawings. Alternatively, it will be appreciated by those skilled in the art that the mount collars 8 may be affixed or attached to the corresponding wing base 3 of each of the decoy wings 1 in any desired manner, such as gluing, welding, (in the case of metal decoy wings 1) and the like, according to the knowledge of those skilled in the art. The mount collars 8 are typically constructed of such materials as plastic, nylon, fiberglass, metal and the like, in non-exclusive particular.

Referring now to FIGS. 3-5 of the drawings, in a preferred embodiment of the invention each mount collar 8 is hollow and characterized by a round collar bore 9 that extends longitudinally from an open end, through the mount collar 8 and terminates at a collar base 12 at the opposite end thereof, nearest the wing base 3. Under circumstances where the decoy wings 1 are each characterized by a corresponding rod mount rod 6, extending through a companion rod opening 7 in the decoy wings 1, the projecting end of each mount rod 6 is seated in the collar base 12 of a corresponding mount collar 8 and is typically secured therein by means of a rod mount pin 10. Furthermore, a ferrous material such as a magnet 11 is glued or otherwise secured in the collar bore 9 of each mount collar 8, typically against the collar base 12, as further illustrated in FIGS. 4 and 5, to facilitate a magnetic attraction between the ferrous wing drive shafts 14, one of which is illustrated in FIGS. 4 and 5, and the magnets 11, respectively, as each ferrous wing drive shaft 14 is extended into the corresponding collar bore 9 and seats against a magnet 11. Accordingly, when each of the ferrous wing drive shafts 14 is so seated in a companion collar bore 9 of a mount collar 8 as illustrated in FIG. 4 of the drawings, rotation of the ferrous wing drive shafts 14 by operation of the motor (not illustrated) located inside the decoy 13 causes rotation of the decoy wings 1 at a speed determined by the rotational speed of the ferrous wing drive shafts 14. It has been surprisingly been found that rotation of the ferrous wing drive shafts 14 as illustrated in FIG. 1 also causes rotation of the decoy wings 1 at the same speed, with little or no slippage, in spite of the wind resistance against the decoy wings 1. However, it has also been found that contact between one or more of the decoy wings 1 with an obstruction such as a stump or the like, on a body of water which floats the decoy 13, will facilitate slippage of each of the decoy wings 1 with respect to the ferrous wing drive shafts 14 as the corresponding mount collar 8 rotates with respect to each ferrous wing drive shaft 14, to prevent damage to either of the decoy wings 1, the decoy 13 or even to the motor itself located inside the decoy 13, as well as the ferrous drive shafts 14. Accordingly, this capacity for removably mounting the decoy wings 1 in a quick and efficient manner on the respective ferrous drive shafts 14 using the magnet 11, facilitates rotation of the decoy wings 1 at substantially any desired speed determined by the predetermined rotational speed of the drive shafts 14, and yet facilitates a “slip clutch” effect to minimize damage to the decoy wings 1 or other rotational or fixed parts of the decoy 13, in the event of collision of the decoy wings 1 with a fixed object. Furthermore, removal of the decoy wings 1 from the respective wing drive shafts 14 is easily achieved by simply exerting outward pressure on the decoy wings 1 to break the magnetic attraction between the ends of the ferrous wing drive shafts 14 and the corresponding magnets 11. The ease of installation and removal of the decoy wings 1 to and from the corresponding ferrous wing drive shafts 14 is important, since assembly and disassembly of the decoy wings 1 must frequently be achieved in the dark and in all kinds of weather.

It will be appreciated by those skilled in the art that the mount collars 8 may have collar bores 9 of selected size for slip-fitting on corresponding, slightly undersized, wing drive shafts 14. Alternatively, a single collar bore diameter can be provided in each of the mount collars 8, for mounting on various sized ferrous wing drive shafts 14, using conventional inserts (not illustrated) that are available in the art. The inserts act as adaptors and are simply slipped inside the mount collars 8 or on the ferrous wing drive shafts 14 of corresponding insert size, such that the ends of the ferrous wing drive shafts 14 contact the corresponding magnets 11, located in the corresponding collar bores 9 of the mount collars 8, to facilitate the desired removable attachment of the decoy wings 1 on the respective ferrous wing drive shafts 14.

It will be further appreciated by those skilled in the art that the decoy wings 1 of this invention can be of any desired size, coloring and shape, to simulate waterfowl or game birds of any description, including ducks, geese, crows, dove, pheasant, quail and other birds, in non-exclusive particular. Moreover, the decoy wings 1 can be of disproportionate size with respect to the decoy body, to facilitate greater visibility of the birds, depending upon location and weather conditions. The decoy wings 1 of this invention are further designed to fit on any decoy having a ferrous wing drive shaft 14 of any size, as illustrated in FIGS. 1, 4 and 5 of the drawings. As described above, under circumstances where the ferrous wing drive shafts 14 are smaller than the typically 5/16 inch ferrous wing drive shafts used in many decoys, conventional adaptor inserts can be inserted in the collar bore 9 of each of the mount collars 8 to facilitate adaptation of the ferrous wing drive shafts 14 to the mount collars 8. The key factor in using the adaptor inserts for insertion of the mount collars 8 on the respective ferrous wing drive shafts 14, is contact between the ends of the ferrous wing drive shafts 14 and the respective magnets 11, to facilitate the desired removable attachment between the decoy wings 1 and the decoy 13.

While the preferred embodiments of the invention have been described above, it will be recognized and understood that various modifications may be made in the invention and the appended claims are intended to cover all such modifications which may fall within the spirit and scope of the invention.

Having described my invention with the particularity set forth above, what is claimed is:

1. A decoy wing for mounting on the ferrous operating shaft of a decoy, comprising a wing base and a wing tip spaced from said wing base; a mount collar provided on said wing base for removably receiving the ferrous operating shaft; and a ferromagnetic material provided in said mount collar for contacting and attracting the ferrous operating shaft and removably retaining said decoy wing on the ferrous operating shaft.

2. The decoy wing of claim 1 comprising a mount rod extending through said decoy wing from said wing base toward said wing tip, with one end of said mount rod projecting from said wing base and fixed to said mount collar for mounting said decoy wing on said mount collar.

3. The decoy wing of claim 1 comprising an adhesive applied to said ferromagnetic material for securing said ferromagnetic material in said mount collar.

4. The decoy wing of claim 3 comprising a mount rod extending through said decoy wing from said wing base toward said wing tip, with one end of said mount rod projecting from said wing base into said mount collar and a mount pin extending through said mount collar and said mount rod for securing said mount rod in said mount collar and mounting said decoy wing on said mount collar.

5. The decoy wing of claim 1 comprising an adhesive applied to said mount collar for securing said ferromagnetic material in said mount collar.

6. The decoy wing of claim 5 comprising a mount rod extending through said decoy wing from said wing base toward said wing tip, with one end of said mount rod projecting from said wing base into said mount collar and a mount pin extending through said mount collar and said mount rod for securing said mount rod in said mount collar and mounting said decoy wing on said mount collar.

7. A pair of decoy wings for mounting on the oppositely-disposed, rotatable ferrous metal shafts of a decoy, each of said decoy wings comprising a wing base and a wing tip spaced from said wing base; a mount collar having an open end and a mount collar bore extending from said open end for receiving a respective one of the rotatable ferrous metal shafts, and a mount collar base provided in the opposite end of said mount collar from said open end; and a magnet fixed in said mount collar bore for contacting and attracting the rotatable ferrous metal shafts, respectively, and removably retaining said decoy wings on the rotatable ferrous metal shafts.

8. The decoy wings of claim 7 wherein said decoy wings each comprises a plastic corrugated core and comprising a mount rod extending through said plastic corrugated core of said decoy wings, from said wing base toward said wing tip, with one end of said mount rod projecting from said wing base and fixed to said mount collar.

9. The decoy wings of claim 7 comprising an adhesive applied to said magnet for securing said magnet in said mount collar.

10. The decoy wings of claim 7 comprising:
(a) a mount rod extending through each of said decoy wings from said wing base toward said wing tip, respectively, with one end of said mount rod projecting from said wing base into said mount collar, respectively, and a mount pin extending through said mount collar and said mount rod for securing said mount rod in said mount collar and mounting said decoy wings on said mount collar, respectively; and
(b) an adhesive applied to said magnet for securing said magnet in said mount collar, respectively.

11. The decoy wing of claim 7 comprising an adhesive applied to said mount collar for securing said magnet in said mount collar, respectively.

12. The decoy wings of claim 7 comprising:
(a) a mount rod extending through each of said decoy wings from said wing base toward said wing tip, respectively, with one end of said mount rod projecting from said wing base into said mount collar, respectively, and a mount pin extending through said mount collar and said mount rod for securing said mount rod in said mount collar and mounting said decoy wings on said mount collar, respectively, and;
(b) an adhesive applied to said mount collar for securing said magnet in said mount collar, respectively.

13. A method of removably mounting a pair of decoy wings on the oppositely-disposed ferrous operating shafts of a decoy, comprising the steps of:
(a) providing a mount collar having a longitudinal shaft bore, on each of said decoy wings;
(b) fixing a magnet in said shaft bore of said mount collar; and
(c) inserting said mount collar on said ferrous operating shafts, respectively, until the ferrous operating shafts contact said magnet in said shaft bore of said insert collar, respectively, for removably securing said decoy wings on the ferrous operating shafts by magnetic attraction between said magnet and the ferrous operating shafts, respectively.

14. The method according to claim 13 comprising the steps of inserting a mount rod in each of said decoy wings and fixing one end of said mount rod in said mount collar, respectively.

15. The method according to claim 14 comprising the step of extending a mount pin through said mount collar and said mount rod for securing said mount rod on said mount collar, respectively.

16. The method according to claim 13 comprising gluing said magnet in said shaft bore of said mount collar, respectively.

17. The method according to claim 13 comprising the steps of:
(a) inserting a mount rod in each of said decoy wings and fixing one end of said mount rod in said mount collar, respectively; and
(b) gluing said magnet in said shaft bore of said mount collar, respectively.

18. The method according to claim 17 comprising the step of extending a mount pin through said mount collar and said mount rod for securing said mount rod on said mount collar, respectively.

19. The method according to claim 13 wherein said decoy wings are characterized by a corrugated core.

20. The method according to claim 19 comprising the steps of inserting a mount rod in said corrugated core of each of said decoy wings and fixing one end of said mount rod in said mount collar, respectively.
